(19) United States
(12) Patent Application Publication
(10) Pub. No.: US 2002/0186482 A1
(43) Pub. Date: Dec. 12, 2002

(54) Mirror assembly for a vehicle

(76) Inventors: Heinrich Lang, Ergersheim (DE); Albrecht Popp, Weihenzell (DE)

Correspondence Address: DORITY & MANNING, P.A., POST OFFICE BOX 1449, GREENVILLE, SC, 29602-1449, US

(21) Appl. No.: 10/147,525

(22) Filed: May 17, 2002

(30) Foreign Application Priority Data
Jun. 8, 2001 (DE) 10127886.1

(51) Int. Cl. G02B 7/182

(52) U.S. Cl. 359/871

(57) ABSTRACT

The invention provides a mirror assembly for a vehicle, especially for a commercial vehicle, for the supervision of at least a partial area in the travel direction of the vehicle. The mirror assembly has at least a mirror pane enclosing mirror housing, which can be affixed to the vehicle with at least one holding arm within the visual area of the driver. The holding arm can be fastened on a windshield above the sitting height of a driver in the direction of travel of the vehicle. A holding plate, on which the holding arm is secured, can be adhesively, retrofittingly attached on a part of the body of the vehicle, especially on the windshield or front pane.

### FIELD OF THE INVENTION

The invention concerns an outside mirror for motor vehicles, particularly for commercial vehicles, for monitoring at least a part of an area in a direction of travel of the vehicle.

### BACKGROUND OF THE INVENTION

In the case of motor vehicles, especially trucks or omnibuses, a driver may not be able to see fully the area in the travel direction of the vehicle. For example, the blindspot in front of the forward windshield pane is only conditionally visible and often cannot be seen or monitored down to the surface of the road. There is a constant danger, particularly in the case of omnibuses, that persons might be unseen immediately in front of the omnibus. School children in particular cannot be seen in the blindspot; thus, they are at greater risk in the vicinity of omnibuses or like vehicles.

Many standard outside mirrors, such as those mirrors installed on the factory production line, do not have the capability of eliminating the blindspot problem, since they are intended for use exclusively as rearview mirrors. That is, the standard rearview mirrors enable views to the rear of the vehicle, or when installed on the sides of the vehicle, for monitoring the entry/exit doors.

Presently, where commercial vehicles such as trucks and omnibuses are concerned, ongoing efforts are being made to allow the driver to monitor the space in the travel direction in front of the vehicle. In many new vehicles, for instance, in addition to the rearview and maneuvering mirror, an additional mirror is placed on the vehicle body during production. This additional mirror may be bolted to the vehicle to give the driver a view of the space before the vehicle. However, in the case of vehicles already in operation, a problem arises in which an additional mirror, or if required, two such mirrors (one on the driver side and one on the passenger side), cannot be placed on the vehicle body. Specifically, the existing rear and maneuvering mirrors and their supports take up the available space needed for another mirror to monitor the blindspot in front of the vehicle.

### BRIEF SUMMARY OF THE INVENTION

The present invention makes available an outside mirror, which can be retrofitted on vehicles that are in operation or on standby without problems and without great expense. For example, time and labor for boring and bolting operations on the body can be avoided by utilizing the present invention.

Specifically, in one aspect of the invention a holding plate from which at least one holding arm extends is provided. A mirror-encapsulating housing is placed on the at least one holding arm. The holding plate, which serves as the mirror assembly retaining medium, can be adhesively retrofit onto a part of the vehicle body, particularly onto the windshield or front pane.

Certain expensive fastening requirements may be avoided by the inventive retrofit feature in which the holding plate is adhesively affixed to the windshield of the vehicle, for example. More specifically, the fastening of a holding plate on locations on the body or parts of the vehicle by classic fastening methods, notably a holding plate which is to be bolted on, can be only carried out under certain circumstances. Often, such methods may not be used at all because the windshield pane cannot tolerate drilling or screwing stresses in which the holes are to be drilled are close together.

Because of the feature of the inventive retrofit capabilities, the outside mirror of the present invention can be installed on a need basis. This is convenient in many cases, for example, where certain vehicle types do not require outside mirrors with which the forward area in the travel direction can be observed or where such mirrors are not necessary or are not desirable. By way of example, these types of outside mirrors, which are usually installed during vehicle production may be unnecessary or undesirable to a prospective buyer who may not be willing to spend extra for a special outside mirror at the time of vehicle purchase.

Due to the flexibility of the retrofit capability, the decision whether to install special mirrors during vehicle production can be conveniently postponed, since the outside mirror for monitoring at least a portion of the area in the direction of travel in front of the vehicle can be installed upon the wish of the customer at anytime, including retrofitting the mirror onto the vehicle. Accordingly, certain vehicle specifications or customer preferences can be given consideration at any time without difficulty. Further, vehicles that are already in operation, can be immediately retrofitted with the invented outside mirror, especially in the case of omnibuses to bolster their safe operation.

The holding arm in one aspect of the invention is installed on the holding plate in a movable, adjustable manner. This is done, for example, by providing a universal spherical joint between the holding plate and the holding arm to provide freedom of movement in any direction.

Alternatively, or in addition to the configuration above, between the other (free end) of the holding arm and the mirror housing, a correspondingly designed adjustable linkage can be found. With this additional linkage, if desired, the holding arm could be rigidly affixed to the holding plate or only held there by a coupling to permit a simple, single degree freedom of motion, i.e., movement in one direction.

In normal operation, the position of the holding arm is fixed in reference to the holding plate and substantially immovable. However, upon a predetermined force applied to the secured holding arm, the rigid connection is releasable. For example, if the outside mirror strikes against an obstruction, the attachment should release so that the holding arm, together with the mirror housing, yields to the impinging force and swings away undamaged.

In accordance with one aspect of the invention, the holding plate is adhesively secured in the area of the upper windshield. Accordingly, a greater distance between the mirror surface and the area to be observed is created, which permits a correspondingly larger field of view. The adhesive retention of the holding plate to the glass of the windshield in this aspect is formed in successive layers; i.e., glass—primer—adhesive—holding element.

The application of the primer onto the windshield before the adhesive “roughens” the glass surface, so that the applied adhesive has better holding properties. The choice of adhesives include: silicone, epoxy, polyurethane, as well as two-component adhesives, single-component adhesives or other weather-, UV-, and age-deterioration resistant adhesives.

According to another aspect of the invention, a method is disclosed to adapt the holder plate to form-fit the substrate onto which the holder plate will be affixed by adhesion. If, for example, the holding plate is intended to adhere to a convexly bulged location on the windshield pane or an area of the body, the plate should possess a correspondingly complementary concave or spherical, inverted cup-form in order to fit itself against the convex contour of the adhesion surface. A plurality of different holding plates, which possess different bulge contours or radii of curvature, can be provided in order to have the best possible fit at the adhesion area in a particular application.

According to the method, it is also possible to make the holding plate out of thermoplastic material, which prior to actual process of applying the adhesive material, is warmed. The warmed holding plate is pliant and when pressed onto the area of application, takes on a shape of the local contour. After cooling, the rigidity of the thermoplastic returns and the actual adhesive process can proceed.

In accordance with another aspect of the invention, to fit the holding plate as well as possible to the area of adhesion, the holding plate is formed from at least two partial plates, which are flexibly linked together. In this manner, the at least two partial plates are fitted against the windshield bulge, for example, curving about a thin linkage or draw flexibly linking the plates together.

In yet another aspect to achieve a conformance, a kind of adaptation to or meeting the contour of the bulging or spherically shaped substrate is possible by combining the foregoing embodiments. In other words, the at least two mutually connected partial plates of the holding plate can have, respectively, a concave or a spherically inverted cuplike form such that each partial plate complements the area of the windshield or mirror to which it is specifically attached while the linkage molds the partial plates unitarily across the entire contour.

### BRIEF DESCRIPTION OF THE DRAWINGS

Additional details, aspects and advantages of the present invention are available in the following descriptions with the aid of the drawings in which:

FIG. 1 is a partial sectional view of one embodiment of a holding plate adhesively secured to a part of a vehicle in accordance with certain aspects of the invention;

FIG. 2 is a cross-sectional side view of an alternative holding plate, which includes two linked, partial plates; and

FIG. 3 is a cross-sectional side view of another embodiment of a holding plate exhibiting an alternative linkage.

### DETAILED DESCRIPTION OF THE INVENTION

Detailed reference will now be made to the drawings in which examples embodying the present invention are shown. The drawings and detailed description provide a full and detailed written description of the invention, and of the manner and process of making and using it, so as to enable one skilled in the pertinent art to make and use it, as well as the best mode of carrying out the invention. However, the following description of embodiments of the present invention is to be understood as purely illustrative and in no way limiting. A multiplicity of modifications and variants is possible without deviating from the scope of the present invention.

The detailed description uses numerical and letter designations to refer to features in the drawings. Like or similar designations in the drawings and description have been used to refer to like or similar parts of the invention.

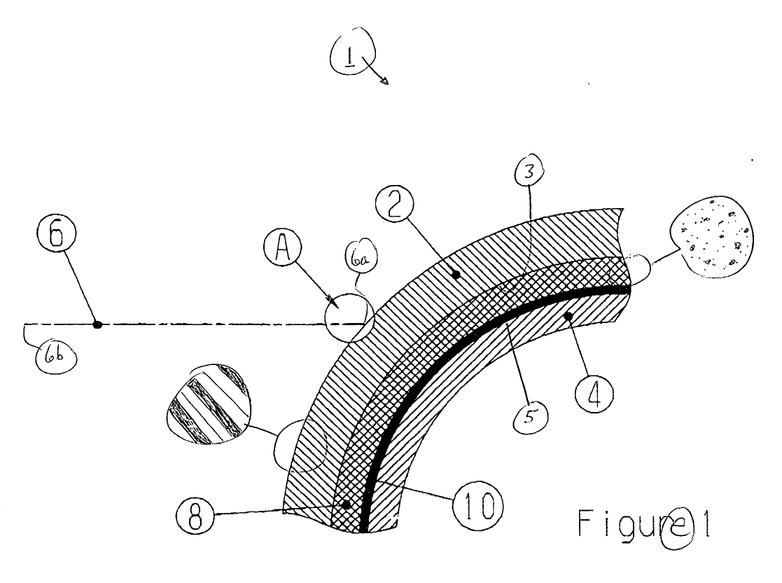

FIG. 1 shows one embodiment of the invention in which a mirror assembly I with a holding plate 2 is affixed by adhesive 8 onto a part of the body 4 of a vehicle (not shown). The body part 4 may be a windshield or front pane, for example, in which the holding plate 2 is placed within a line of sight of a driver and above the sitting height of the driver. FIG. 1 further illustrates that the holding plate 2 carries a holding arm 6, which is indicated simply by a dotted line. The holding arm 6 is, within a circle or connection area A, bound to the holding plate 2 in an appropriate manner via a proximal end 6a of arm 6.

A plurality of construction methods are available to connect the holding plate 2 and the holding arm 6. Among these could be a simple pivotal linkage, a spherical universal joint, a rigid connection, a bolt or screw union, a plug-in connection, a clamp connection, a bayonet fixture, or the like. The location of the holding arm 6 is selected relative to the holding plate 2 such that when a predetermined force acts upon the holding point within circle A in excess of a specified amount, the holding plate 2 and the holding arm 6 cooperably yield to the force by a swinging action occurring at the connection area A.

To fasten the holding plate 2 onto the body 4, an adhesive 8 is employed. Possible adhesives may include those having an epoxy, silicone or polyurethane base. The adhesive 8 should be at least 3 mm thick, especially when the adhesive 8 has a silicone base in order to assure full adhesion between the body 4 and the holding plate 2 even under circumstances where the holding plate 2 slightly deviates from the contour of the body part 4. Other possible adhesives are single or two-part component adhesives including those which are UV- or heat-curable. Stated alternatively, a variety of adhesives may be chosen depending upon the given adhesion procedure, circumstances or conditions.

With further reference to FIG. 1, the complementary form of the holding plate 2 corresponds advantageously to the shape of the body part 4 in order to achieve the greatest possible uniformity in the thickness of the layer of the adhesive 8 and an optimal adaptation of the holding plate 2 to the fastening area of the body part 4. For instance, in the case of an upwardly convexly bulging part 5 of the body part 4 in the upper area of a vehicle as seen in FIG. 1, the adherent surface 3 of the holding plate 2 exhibits a corresponding concave or spherical, cuplike formation, so that the two adjacently lying surfaces 3, 5, with the adhesive 8 between them, run essentially parallel to one another. Thus, an adhesive bed 8 of predominately uniform thickness is assured.

In accordance with a further aspect of the invention, if the body part 4 is a windshield, i.e. front pane, then between this pane and the adhesive material 8, a primer 10 is applied before the application of the adhesive 8 onto the surface 4 on which the adhesion is to take place. It is to be noted that FIG. 1 grossly exaggerates the thickness of the layer 10 for illustration purposes. Such a primer 10 serves as a kind of a base or to provide adherency, to inhibit oxide coatings, to rough the area for application, etc., and thus bring about a better holding power for the adhesive 8 on part 4 and subsequently, a better binding between the body part 4 and the holding plate 2.

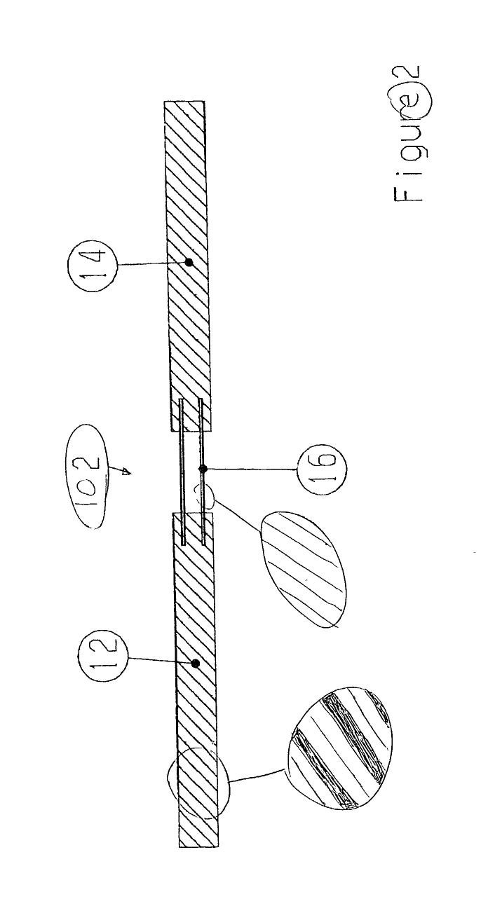

Instead of the method of fitting the shape of the holding plate 2 in accord with FIG. 1, this can also be done in accord with FIG. 2 in which a holding plate 102 is constructed from at least two parts or partial plates 12, 14. In the alternative holding plate 102, these two plates 12, 14 are bound to one another by an appropriate linkage or hinge connection 16. In this aspect, a better fit or intercontact of the holding plate 102 to the corresponding part of the body 4 is possible since each plate 12, 14 has less surface area to form-fit across a respective area of body 4. It should be noted that a plurality of plates with multiple linkages may also be used in accordance with this aspect of the invention. Further, the linkage 16 in FIG. 2 is shown as two parallel elements but only one or a multiplicity of elements having various shapes and orientations could be substituted for the linkage 16 as shown without adversely affecting the invention.

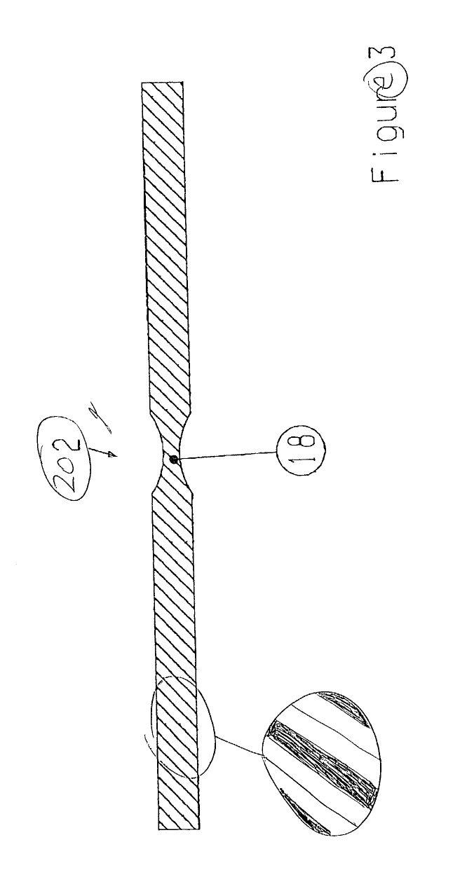

In accordance with an alternative aspect of the invention, instead of the two-part construction of the holding plate 102 with the two partial plates 12, 14, a one piece structure 202 having one draw or “thinning” 18 in the material of the holding plate 202 is provided in FIG. 3. The thin linkage 18 functions as a hinge and imparts a movability to the holding plate 202 for better contact or conformation to the applicable surface contour similar to the foregoing embodiment.

In another aspect of the invention as seen in FIG. 1, a free or distal end 6b of the holding arm 6 carries a mirror housing (not shown) in which a mirror pane (not shown) is seated. Further detail of the mirror housing and mirror pane need not be given to practice the invention. In the case of the mirror housing in this aspect, which has been built to large proportions, it is possible to provide two holding plates, independent from one another, from which two holding arms 6 extend and cooperate to carry the single large mirror housing at two free ends 6b.

The foregoing embodiments are examples of joining the holding plates 2, 102, 202 with the body part 4 utilizing an adhesive 8. In particular, a problem-free retrofit of the invented outside mirror to the windshield of the front pane is assured. Further, an especially high degree of flexibility and installation possibilities are achieved, which are especially important in retrofit operations.

It will be apparent to those skilled in the art that various modifications and variations can be made in the present invention without departing from the scope and spirit of the invention. For example, specific shapes of various elements of the illustrated embodiments may be altered to suit particular applications. It is intended that the present invention include such modifications and variations as come within the scope of the appended claims and their equivalents.

11. A mirror assembly for a vehicle, comprising
a housing having a mirror pane;
at least one holding arm having a distal end and a proximal end, the distal end configured to hold the housing and the mirror pane in a line of sight of a driver;
a holding plate configured to be adhesively affixed to a portion of the vehicle, the proximal end attached to the holding plate.

12. A mirror assembly as in claim 11, wherein the mirror pane is disposed above a sitting height of the driver such that the driver monitors an area in a direction of travel of the vehicle.

13. The mirror assembly as in claim 12, wherein the direction of travel is a direction external to a window of the vehicle.

14. The mirror assembly as in claim 13, wherein the window is a windshield.

15. The mirror assembly as in claim 11, wherein the holding plate is thermoplastic, the thermoplastic holding plate configured to be heated such that a part of the thermoplastic holding plate can be pressed against the portion of the vehicle to form a complementary receiving surface substantially form-fitting the portion.

16. The mirror assembly as in claim 15, wherein the heated holding plate is configured to cool to an ambient temperature such that the cooled holding plate returns to a pre-heated state.

17. The mirror assembly as in claim 11, further comprising an adhesive disposed between the portion of the vehicle and the holding plate, the adhesive configured to adhere the holding plate to the portion.

18. The mirror assembly as in claim 17, wherein the adhesive is selected from the group consisting of silicone, epoxy, polyurethane, and combinations thereof.

19. The mirror assembly as in claim 11, wherein the proximal end is movably attached to the holding plate.

20. The mirror assembly of claim 19, further comprising a spherical universal joint disposed between the proximal end and the holding plate, the spherical universal joint configured to move the holding arm in a plurality of directions relative to the holding plate.

21. The mirror assembly of claim 19, further comprising a hinge disposed between the proximal end and the holding plate, the hinge configured to move the holding arm away from an impacted obstruction.

22. The mirror assembly as in claim 21, wherein the holding arm is configured to move by a predetermined impact force.

23. The mirror assembly as in claim 11, wherein the holding plate is adhesively affixed to a windshield of the vehicle.

24. The mirror assembly as in claim 23, further comprising a primer disposed between the windshield and the holding plate, the primer configured to prepare the windshield for receipt of an adhesive.

25. The mirror assembly as in claim 24, wherein the primer inhibits an oxide coating on the windshield.

26. The mirror assembly as in claim 24, wherein the primer roughens the windshield in preparation for the adhesive.

27. A method for attaching a mirror assembly having a housing, a holding arm, and a mirror pane to a portion of a vehicle, the method comprising the steps of:
providing a holding plate having a first surface and a second surface, the first surface configured to hold the holding arm, the second surface configured to be shaped to fit the portion of the vehicle;
shaping the second surface to fit the portion;
applying an adhesive to the portion;
fitting the second surface to the adhesive such that the adhesive is disposed between the portion and the second surface; and
curing the adhesive such that the second surface is adhesively attached to the portion of the vehicle.

28. The method as in claim 27, wherein the holding plate is thermoplastic and the shaping step includes the substeps of heating the holding plate to a point before a melting point of the holding plate such that the heated holding plate is malleable, pressingly form-fitting the heated holding plate to the portion to complement a shape of the portion, and cooling the holding plate such that the holding plate substantially returns to a preheated condition.

29. The method as in claim 27, wherein the shaping step includes the substep of heating the holding plate to a point before a melting point such that the heated holding plate is malleable.

30. The method as in claim 27, wherein the shaping step includes the substep of bending the holding plate to form-fit the shape of the portion.

31. The method as in claim 27, wherein the portion is glass and further comprising the step of applying a primer configured to prepare the glass to receive the adhesive before the step of applying the adhesive.

32. The method as in claim 27, wherein the adhesive is cured by the substeps selected from the group consisting of ambient air drying, treating by ultraviolet radiation, heating, and combinations thereof.

33. The method as in claim 27, further comprising the substep of applying the adhesive to a part of a windshield disposed proximate a roof of the vehicle such that a driver monitors an area in a direction of movement of the vehicle.

34. A mirror assembly for a vehicle comprising:
a housing having a mirror pane, the housing attached to a holding arm; and
a holding plate attached to the holding arm disposed apart from the housing, the holding plate having at least two partial plates attached to each other by a linkage, the holding plate configured to be retrofitted on a portion of the vehicle.

35. The mirror assembly as in claim 34, wherein the housing is movably attached to the holding arm located apart from the holding plate.

36. The mirror assembly of claim 34, wherein the holding arm is a plurality of holding arms and the holding plate is a plurality of holding plates, the housing attached to the plurality of holding arms, the holding arms affixed to the plurality of holding plates, the plurality of holding plates disposed apart from each other and adhesively affixed to the vehicle.

37. The mirror assembly of claim 36, wherein the housing is adjustably attached to the plurality of holding arms.

38. The mirror assembly of claim 34, wherein the at least two partial plates are a plurality of partial plates and the linkage is a plurality of linkages, the plurality of partial plates flexibly attached to each other by the plurality of linkages.

39. The mirror assembly as in claim 34, wherein the at least two partial plates are thermoplastic, the at least two thermoplastic partial plates configured to be heated to a point before a melting point such that the heated partial plates can be formed to the shape of the portion.

40. The mirror assembly as in claim 34, wherein the linkage is configured to bend across a curvature of the portion such that the at least two partial plates fit to the portion.

41. The mirror assembly as in claim 34, further comprising an adhesive and a primer, the primer configured to prepare the portion to receive the adhesive, the adhesive configured to adhere to the primer and to the holding plate such that the holding plate adheres to the portion.

42. The mirror assembly of claim 41, wherein the adhesive is selected from the group consisting of silicone, epoxy, polyurethane, and combinations thereof.

43. The mirror assembly as in claim 34, further comprising an adjustable linkage configured to move the housing and the holding arm away from an obstacle.

44. The mirror assembly as in claim 43, wherein the adjustable linkage is electrically adjustable from a remote site.

45. The mirror assembly as in claim 44, wherein the adjustable linkage is adjustable by an impact force.

46. A mirror assembly for a vehicle having a housing, a mirror pane, and a holding arm, the mirror assembly comprising:
a thermoplastic holding plate having a first surface, a second surface, a first end, a second end, and a draw disposed substantially between the first end and the second end, the thermoplastic holding plate configured to be heated to a point less than a melting point and shaped to fit a portion of the vehicle, the second surface of the shaped holding plate configured to be adhesively affixed to the portion, the holding arm affixingly disposed between the first surface of the holding plate and the housing.

47. The mirror assembly of claim 46, wherein the first and second surfaces define a height greater than a height of the draw, such that the draw tends to bend to a radius curvature of the portion before a remainder of the holding plate bends.
